(19) United States
(12) Patent Application Publication
(10) Pub. No.: US 2025/0065414 A1
(43) Pub. Date: Feb. 27, 2025

(54) MONOLITHIC MULTI-OPTICS SCANNER HEAD

(71) Applicant: Divergent Technologies, Inc., Los Angeles, CA (US)

(72) Inventors: Seyedalireza TORBATISARRAF, Los Angeles, CA (US); Konstantin WIPLINGER, Rancho Palos Verdes, CA (US); Michael Thomas KENWORTHY, Rancho Palos Verdes, CA (US)

(21) Appl. No.: 18/815,568

(22) Filed: Aug. 26, 2024

Related U.S. Application Data
(60) Provisional application No. 63/578,963, filed on Aug. 25, 2023.

(51) Int. Cl. B22F 12/49; B33Y 30/00; B33Y 80/00

(52) U.S. Cl. CPC B22F 12/49; B33Y 30/00; B33Y 80/00

(57) ABSTRACT

Apparatus and system for optimizing package of scanner heads is disclosed. An apparatus in accordance with an aspect of the present disclosure comprises a monolithic multi-optics scanner head housing configured to receive multiple sets of galvanometer mirror scanners (galvo) and a beam entry window. Each set of galvos receives a laser and redirects the laser using a mirror.

### CROSS-REFERENCE TO RELATED APPLICATIONS

This application claims priority to U.S. Provisional Application No. 63/578,963 titled “MONOLITHIC MULTI-OPTICS SCANNER HEAD,” filed on Aug. 25, 2023, which is assigned to the assignee hereof, and incorporated herein by reference in its entirety as if fully set forth herein.

### BACKGROUND

### Field

The present disclosure relates generally to additive manufacturing, and more specifically to increasing the productivity of printing with individual scanner head overlaps.

### Background

Three-dimensional (3-D) printing, also referred to as additive manufacturing (AM), has recently presented new opportunities to more efficiently build complex transport structures, such as automobiles, aircraft, boats, motorcycles, busses, trains, and the like. AM techniques are capable of fabricating complex components from a wide variety of materials. Applying AM processes to industries that produce these products has proven to produce a structurally more efficient transport structure. For example, an automobile produced using 3-D printed components can be made stronger, lighter, and consequently, more fuel efficient. Moreover, AM enables manufacturers to 3-D print components that are much more complex and that are equipped with more advanced features and capabilities than components made via traditional machining and casting techniques. The 3-D objects may be formed using layers of material based on a digital model data of the object. A 3-D printer may form the structure defined by the digital model data by printing the structure one layer at a time.

In 3D printing, scanners can control or steer a laser beam around in the beam chamber. However, there are a few constraints with this design. First, to maintain the inert environment inside the build chamber and protect the lasers from particles flying around, there should be a window or glass (e.g., beam entry window) to close off that area for each preexisting individual scanner housing with optics in them. However, the windows or glass come in different qualities. For example, there may be a window or glass that is slightly thicker on one side than the other. In addition, the window or glass needs to be replaced after a particular time period due to the degradation and scratches on the window or glass. As another example, soot may accumulate on the top or bottom of the glass and if the soot is not properly cleaned then the coating on the glass may be damaged. If these window or glass needs to be replaced, then the entire system needs to undergo a full optical calibration loop because the new window behaves different than the old one.

### SUMMARY

Several aspects of apparatus for systems and methods for packaging optimization will be described more fully hereinafter with reference to three-dimensional printing techniques.

An apparatus in accordance with an aspect of the present disclosure comprises a monolithic multi-optics scanner head housing configured to receive multiple sets of galvanometer mirror scanners (galvos) and a beam entry window. Each set of galvos receives a laser and redirects the laser using a mirror.

Such an apparatus may optionally include the monolithic multi-optics scanner head housing further comprises a conformal channel with a channel configured for thermal management through the multiple sets of galvos.

Such an apparatus may optionally include each set of galvo further comprises a set of printed—in radiator fins, radiator structure, or heat exchangers for thermal management of the multiple sets of galvos.

Such an apparatus may optionally include the monolithic multi-optics scanner head housing further comprises a single air channel for thermal management of the multiple sets of galvos.

Such an apparatus may optionally include the monolithic multi-optics scanner head housing further comprises a single supply nozzle that is connected to each of the sets of galvos to receive gas.

Such an apparatus may optionally include the monolithic multi-optics scanner head housing further comprises a single data inlet or power inlet that connects to each of the sets of galvos.

Such an apparatus may optionally include the monolithic multi-optics scanner head housing further comprises at least two beam entry window for a plurality of lasers.

Such an apparatus may optionally include the monolithic multi-optics scanner head housing is further configured to receive a camera for process monitoring.

Such an apparatus may optionally include the monolithic multi-optics scanner head housing is further configured to receive a sensor.

Such an apparatus may optionally include the monolithic multi-optics scanner head housing further comprises a set of mounting holes configured to mount each set of galvos, camera, or a sensor and a corresponding single hole for receiving a laser beam.

Such an apparatus may optionally include the monolithic multi-optics scanner head housing further comprises a hexagonal shape such that each side of the hexagonal shape comprises a set of mounting holes configured to receive at least a set of galvos, a camera, or a sensor.

Such an apparatus may optionally include the monolithic multi-optics scanner head housing is additively manufactured.

A system in accordance with an aspect of the present disclosure comprises a monolithic multi-optics scanner head housing configured to receive a single set of galvanometers (galvos) configured to receive a laser and redirect the laser using a mirror. The monolithic multi-optics scanner head housing including a conformal channel with a channel configured for thermal management through the single set of galvos.

It will be understood that other aspects of package optimization and subcomponents will become readily apparent to those skilled in the art from the following detailed description, wherein it is shown and described only several embodiments by way of illustration. One benefit of various embodiments, for example, is that the process of replacing a window or glass may be more streamlined or easier when multiple scanners are consolidated into one head as closely as possible. Accordingly, the benefit of packing the multiple scanners into one package is that rather than dealing with windows for each individual scanner head, you are only using one or two windows for the entire package of consolidated scanners. As will be realized by those skilled in the art, the example embodiments described herein are capable of other and different embodiments, and its several details are capable of modification in various other respects, all without departing from the invention. Accordingly, the drawings and detailed description are to be regarded as illustrative in nature and not as restrictive.

### BRIEF DESCRIPTION OF THE DRAWINGS

Various aspects of apparatus and methods for packaging optimization will now be presented in the detailed description by way of example, and not by way of limitation, in the accompanying drawings, wherein:

FIGS. 1A-1E illustrate respective side views of a 3-D printer system in accordance with an aspect of the present disclosure.

FIG. 2 illustrates a configuration of a schematic of individual multi-head individual scanners.

FIG. 3 illustrates a comparison of schematics of packaging optimization with individual scanners having multi-field overlap and packaging optimization with integrated scanners having multi-field overlap in accordance with an aspect of the present disclosure.

FIG. 4 illustrates different views of a configuration that includes five sets of galvos in accordance with an aspect of the present disclosure.

FIG. 5 illustrates a view of a configuration that shows mounting holes and a laser beam pass through in accordance with an aspect of the present disclosure.

FIG. 6 illustrates a view of a configuration that shows printed—in radiator fins and a heat exchanger in accordance with an aspect of the present disclosure.

FIG. 7 illustrates a view of a configuration that shows thermal cooling channels and inlet/outlets in accordance with an aspect of the present disclosure.

### DETAILED DESCRIPTION

The detailed description set forth below in connection with the drawings is intended to provide a description of exemplary embodiments of joining additively manufactured structures (or structures) and subcomponents, and it is not intended to represent the only embodiments in which the disclosure may be practiced. The term “exemplary” used throughout this disclosure means “serving as an example, instance, or illustration,” and should not necessarily be construed as preferred or advantageous over other embodiments presented in this disclosure. The detailed description includes specific details for the purpose of providing a thorough and complete disclosure that fully conveys the scope of the disclosure to those skilled in the art. However, the disclosure may be practiced without these specific details. In some instances, well-known structures and components may be shown in block diagram form, or omitted entirely, in order to avoid obscuring the various concepts presented throughout this disclosure.

### Additive Manufacturing

Additive Manufacturing (AM) involves the use of a stored geometrical model for accumulating layered materials on a build plate to produce a three-dimensional (3-D) build piece having features defined by the model. AM techniques are capable of printing complex components using a wide variety of materials. A 3-D object may be fabricated based on a computer aided design (CAD) model. The CAD model can be used to generate a set of instructions or commands that are compatible with a particular 3-D printer. The AM process can create a solid three-dimensional object using the CAD model and print instructions. In the AM process, different materials or combinations of material, such as engineered plastics, thermoplastic elastomers, metals, ceramics, and/or alloys or combinations of the above, etc., may be used to create a uniquely shaped 3-dimensional object.

### Components and Terminology in AM

In an aspect of the present disclosure, a component is an example of an AM component. A component may be any 3-D printed component that includes features, such as an interface, for mating with another component. The component may have internal or external features configured to accept a particular type of component. Alternatively or additionally, the component may be shaped to accept a particular type of component. A component may utilize any internal design or shape and accept any variety of components without departing from the scope of the disclosure.

A component interface may be configured to connect to an interface of another component. For example, and not by way of limitation, an interface between components may be a tongue-and-groove structure. The interface may have high precision features or complex geometries that allow them to perform specific functions, including creating connections to spanning structures such as tubes, structural panels, extrusions, sheet metal, and/or other structural members.

For clarity, components may also include relatively simple connection features configured to connect with the more sophisticated network of connection features of the interface to form streamlined connections between structures. While these components may incorporate more basic features, they advantageously may be 3-D printed at a higher print rate. Alternatively, components may be built using a suitable non 3-D print manufacturing technology.

A number of different AM technologies may be well-suited for construction of components in a transport structure or other mechanized assembly. Such 3-D printing techniques may include, for example, directed energy deposition (DED), selective laser melting (SLM), selective laser sintering (SLS), direct metal laser sintering (DMLS), electron beam melting (EBM), powder bed fusion (PBF), and/or other AM processes involving melting or fusion of metallic powders.

As in many 3-D printing techniques, these processes (e.g., PBF systems) can create build pieces layer-by-layer. Each layer or “slice” is formed by depositing a layer of powder and exposing portions of the powder to an energy beam. The energy beam is applied to melt areas of the powder layer that coincide with the cross-section of the build piece in the layer. The melted powder cools and fuses to form a slice of the build piece. The process can be repeated to form the next slice of the build piece, and so on. Each layer is deposited on top of the previous layer. The resulting structure is a build piece assembled slice-by-slice from the ground up. SLS and various other PBF techniques may be well suited to construction of gear cases and other transport structure components. However, it will be appreciated that other AM techniques, such as fused deposition modeling (FDM) and the like, are also possible for use in such applications.

A tongue-and-groove (TNG) structure may be used to connect two or more components at an interface. For example, a tongue portion of one component may extend all the way around a peripheral region as a single protrusion disposed around the peripheral region. The tongue portion of a component may protrude outward along the peripheral region relative to that component, and the lateral extension of the tongue portion can be considered in this view as “coming out” of that component.

A groove portion of an interface is a portion of a second component and may be disposed along a peripheral region of the second component. The groove portion may, but need not, comprise the material of the second component. The groove portion may extend all the way around the peripheral region and may be a single channel in the second component. The groove portion may also be inset inward along the peripheral region relative to the second component and runs laterally around the second component. The tongue and groove may be arranged on the first and second components such that when the two components are placed into contact, the tongue may align with the groove and may fit into the groove around the peripheral regions at the interface between the two components.

AM may include the manufacture of one or more nodes. A node is a structural member that may include one or more interfaces used to connect to other nodes or spanning components such as tubes, extrusions, panels, and the like. Using AM, a node may be constructed to include additional features and functions, including interface functions, depending on the objectives. As described herein, the term node and structure may be used interchangeably.

As described above, nodes and other components may be connected together. For example, one or more nodes and/or other components may be connected together to form larger components. Accordingly, individual AM structures often need to be connected together, or individual AM structures often need to be connected to machined or COTS parts, to provide combined structures, e.g., to realize the above modular network or to form a complex interior assembly in a vehicle. Examples include structure-to-structure connections, structure-to-panel connections, structure-to-tube connections, and structure-extrusion connections, among others. To connect an AM joint member with a vehicle body panel, for example, mechanical connectors (e.g., screws, clamps, etc.) may be used. Alternatively or additionally, an adhesive may be used to form a strong bond. For connecting these parts, a strict tolerance is often required, meaning that the parts must be positioned to fit precisely in an established orientation. For example, the two parts to be adhered may need to be positioned to avoid direct contact with each other in order to mitigate possible galvanic corrosion problems. In general, an adhesive connection between the AM joint member and panel should result in an accurate fit. Thus, the AM joint member should not be misaligned with or offset from the body panel, for example, and the parts should remain properly oriented when a permanent bond is established.

The present disclosure is directed to increasing the productivity of printing by integrating multi-optics scanner heads in a monolithic package. In particular, packaging optimization allows components to be more flexible and closely positioned to maximize the overlapping laser fields. In addition, the packaging optimization may also enable the packaging of more scanner heads in a given size build plate. In addition, to size optimization, the present disclosure also improves thermal management, serviceability, and an opportunity to integrate photodiodes, power monitoring, and other components to add additional process monitoring while minimizing the impact to beam quality.

### Additive Manufacturing Environment

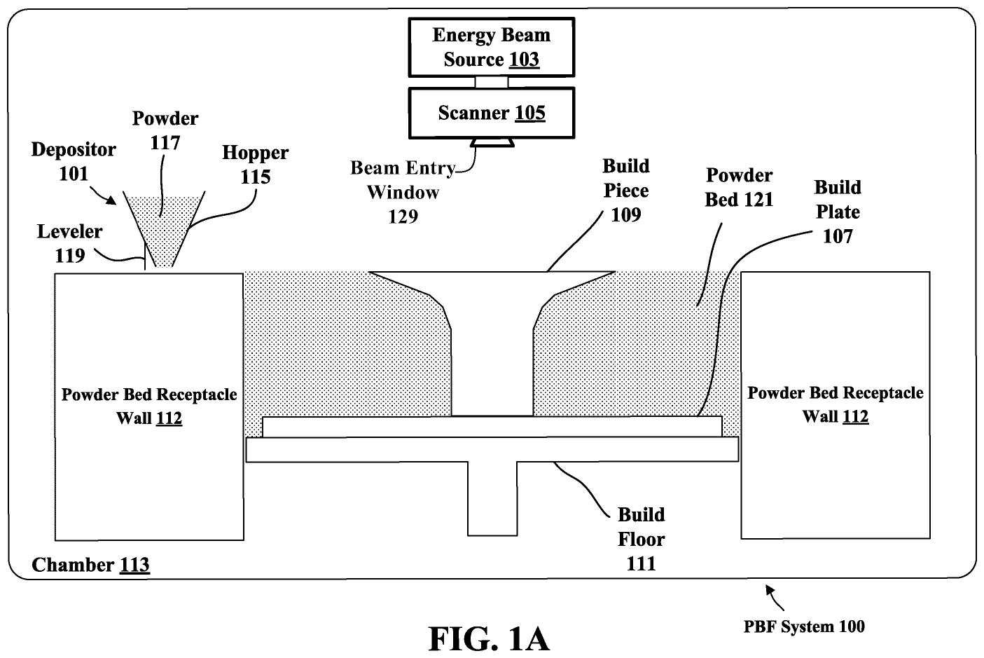

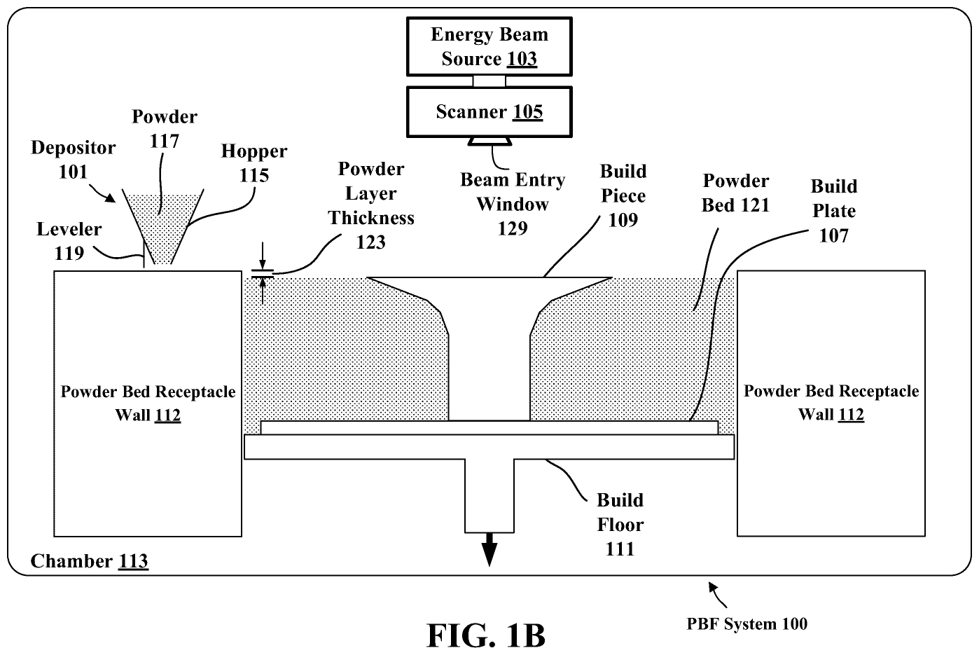

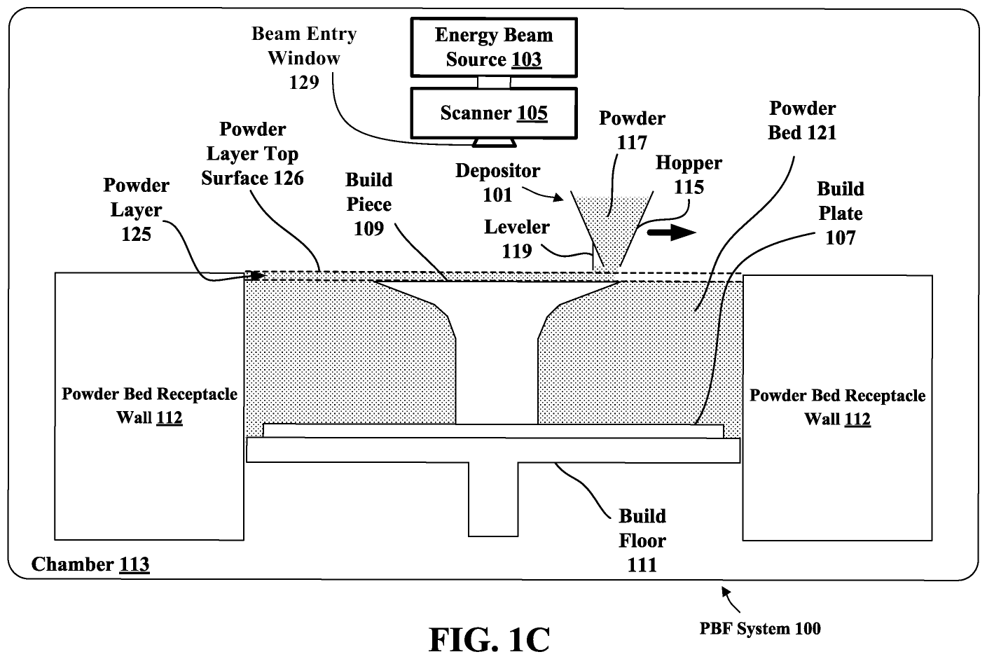

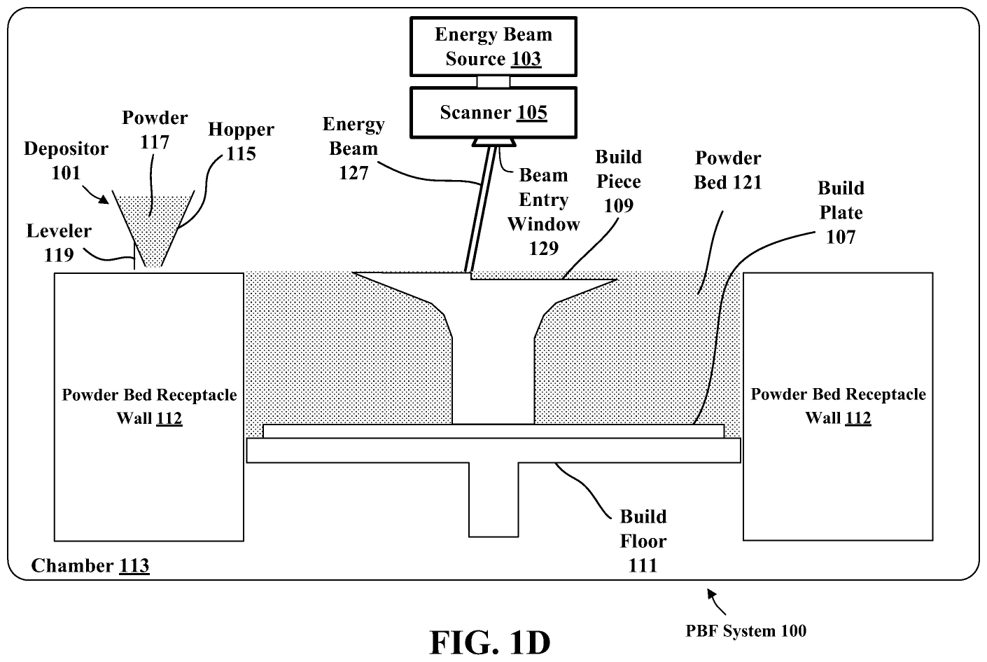

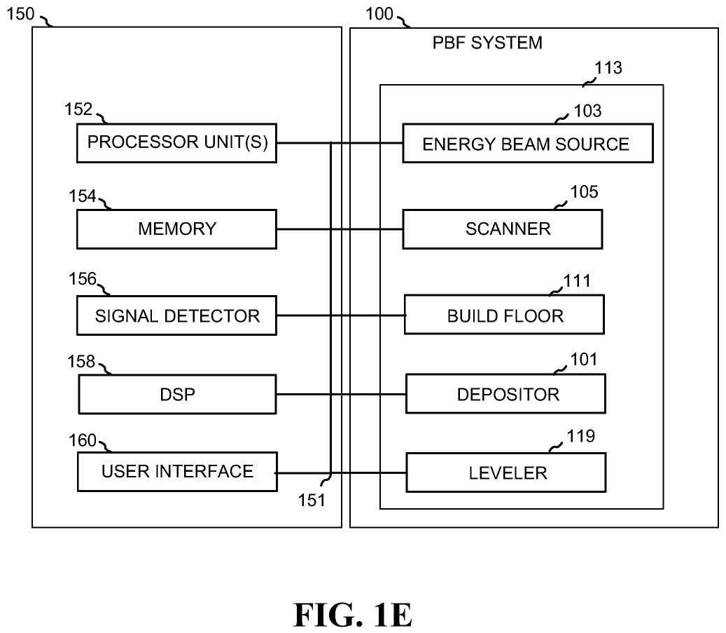

FIGS. 1A-1D illustrate respective side views of a 3-D printer system in an aspect of the present disclosure.

In an aspect of the present disclosure, a 3-D printer system may be a powder-bed fusion (PBF) system 100. FIGS. 1A-D show PBF system 100 during different stages of operation. The particular embodiment illustrated in FIGS. 1A-1D is one of many suitable examples of a PBF system employing principles of this disclosure. It should also be noted that elements of FIGS. 1A-1D and the other figures in this disclosure are not necessarily drawn to scale, but may be drawn larger or smaller for the purpose of better illustration of concepts described herein. PBF system 100 can include a depositor 101 that can deposit each layer of metal powder, an energy beam source 103 that can generate an energy beam, a scanner 105 that can apply the energy beam to fuse the powder material, a beam entry window 129 that protects the optics from the build chamber environment, and a build plate 107 that can support one or more build pieces, such as a build piece 109. Although the terms “fuse” and/or “fusing” are used to describe the mechanical coupling of the powder particles, other mechanical actions, e.g., sintering, melting, and/or other electrical, mechanical, electromechanical, electrochemical, and/or chemical coupling methods are envisioned as being within the scope of the present disclosure.

PBF system 100 can also include a build floor 111 positioned within a powder bed receptacle. The walls of the powder bed receptacle 112 generally define the boundaries of the powder bed receptacle, which is sandwiched between the walls 112 from the side and abuts a portion of the build floor 111 below. Build floor 111 can progressively lower build plate 107 so that depositor 101 can deposit a next layer. The entire mechanism may reside in a chamber 113 that can enclose the other components, thereby protecting the equipment, enabling atmospheric and temperature regulation and mitigating contamination risks. Depositor 101 can include a hopper 115 that contains a powder 117, such as a metal powder, and a leveler 119 that can level the top of each layer of deposited powder.

Referring specifically to FIG. 1A, this figure shows PBF system 100 after a slice of build piece 109 has been fused, but before the next layer of powder has been deposited. In fact, FIG. 1A illustrates a time at which PBF system 100 has already deposited and fused slices in multiple layers, e.g., 200 individual layers, to form the current state of build piece 109, e.g., formed of 200 individual slices. The multiple individual layers already deposited have created a powder bed 121, which includes powder that was deposited but not fused.

FIG. 1B shows PBF system 100 at a stage in which build floor 111 can lower by a powder layer thickness 123. The lowering of build floor 111 causes build piece 109 and powder bed 121 to drop by powder layer thickness 123, so that the top of build piece 109 and powder bed 121 are lower than the top of powder bed receptacle wall 112 by an amount equal to the powder layer thickness 123. In this way, for example, a space with a consistent thickness equal to powder layer thickness 123 can be created over the tops of build piece 109 and powder bed 121.

FIG. 1C shows PBF system 100 at a stage in which depositor 101 is positioned to deposit powder 117 in a space created over the top surfaces of build piece 109 and powder bed 121 and bounded by powder bed receptacle walls 112. In this example, depositor 101 progressively moves over the defined space while releasing powder 117 from hopper 115. Leveler 119 can level the released powder to form a powder layer 125 that leaves powder layer top surface 126 configured to receive fusing energy from energy beam source 103. Powder layer 125 has a thickness substantially equal to the powder layer thickness 123 (see FIG. 1B). Thus, the powder in a PBF system can be supported by a powder material support structure, which can include, for example, a build plate 107, a build floor 111, a build piece 109, walls 112, and the like. It should be noted that the illustrated thickness of powder layer 125 (i.e., powder layer thickness 123 (FIG. 1B)) is greater than an actual thickness used for the example involving the 200 previously-deposited individual layers discussed above with reference to FIG. 1A.

FIG. 1D shows PBF system 100 at a stage in which, following the deposition of powder layer 125 (FIG. 1C), energy beam source 103 generates an energy beam 127 and scanner 105 applies the energy beam to fuse the next slice in build piece 109. In various exemplary embodiments, energy beam source 103 can be an electron beam source, in which case energy beam 127 constitutes an electron beam. Scanner 105 can include deflection plates that can generate an electric field or a magnetic field that selectively deflects the electron beam to cause the electron beam to scan across areas designated to be fused. In various embodiments, energy beam source 103 can be a laser, in which case energy beam 127 is a laser beam. Scanner 105 can include an optical system that uses reflection and/or refraction to manipulate the laser beam to scan selected areas to be fused. Scanner 105 can include, for example, any of the various embodiments of monolithic multi-optics scanner head housings described herein.

In various embodiments, the scanner 105 can include one or more galvos that can rotate to translate the energy beam to position the energy beam through the beam entry window 129. In various embodiments, energy beam source 103 and/or scanner 105 can modulate the energy beam, e.g., turn the energy beam on and off as the scanner scans so that the energy beam is applied only in the appropriate areas of the powder layer via the beam entry window 129. For example, in various embodiments, the energy beam can be modulated by a digital signal processor (DSP).

In various embodiments, the beam entry window 129 is a window (e.g., glass) between the scanner 105 and the chamber 113. In other words, the beam entry window 129 is the window for the energy beam 127 through the chamber 113. The beam entry window 129 is configured to protect the optics from the chamber 113 environment, including soot, splatter, and vapor caused by the laser fusing powder.

In various embodiments, when the beam entry window 129 gets dirty (e.g., from soot collecting on it), the dirtiness may affect the laser beam (e.g., energy beam 127) quality. This reduction in beam quality may be attributed to the dirtiness absorbing the laser beam energy and causing the beam entry window 129 to heat up. This results in thermal distortion of the beam entry window 129, which affects the laser beam as it travels through the distorted beam entry window 129. Therefore, beam entry windows are typically cleaned in between builds and may be scratched or otherwise damaged and need replacing periodically. This periodic replacement of the beam entry window can cause significant downtime for the PBF printer.

In particular, when a beam entry window 129 is replaced, the scanner typically must be recalibrated because even a very small difference from one beam entry window 129 to another can affect the entire system. The recalibration process can be time consuming, and during the recalibration the PBF printer cannot print. This downtime can be a significant cause of printer inefficiency. An advantage of the present disclosure is that the beam entry window 129 may be included with the scanner in a rigid and monolithic housing, and, thus, the entire package may be calibrated offline, eliminating the need to recalibrate after installation on the printer. Accordingly, when a beam entry window 129 on the printer becomes scratched, damaged, or otherwise needs to be replaced, an entire monolithic multi-optics scanner head housing including the scanner head and beam entry window may be swapped out, and a new monolithic multi-optics scanner head including a calibrated scanner head and beam entry window can be easily swapped in. In this way, the new monolithic multi-optics scanner head does not need to be recalibrated after installation in the printer, and the printer downtime can be reduced. The swapped out monolithic multi-optics scanner head housing may be serviced, e.g., by replacing the beam entry window, and re-calibrated offline, ready to be swapped in when needed without additional recalibration.

FIG. 1E illustrates a functional block diagram of a 3-D printer system in accordance with an aspect of the present disclosure.

In an aspect of the present disclosure, control devices and/or elements, including computer software, may be coupled to PBF system 100 to control one or more components within PBF system 100. Such a device may be a computer 150, which may include one or more components that may assist in the control of PBF system 100. Computer 150 may communicate with a PBF system 100, and/or other AM systems, via one or more interfaces 151. The computer 150 and/or interface 151 are examples of devices that may be configured to implement the various methods described herein, that may assist in controlling PBF system 100 and/or other AM systems.

In an aspect of the present disclosure, computer 150 may comprise at least one processor unit 152, memory 154, signal detector 156, a digital signal processor (DSP) 158, and one or more user interfaces 160. Computer 150 may include additional components without departing from the scope of the present disclosure.

The computer 150 may include at least one processor unit 152, which may assist in the control and/or operation of PBF system 100. The processor unit 152 may also be referred to as a central processing unit (CPU). Memory 154, which may include both read-only memory (ROM) and random access memory (RAM), may provide instructions and/or data to the processor. A portion of the memory 154 may also include non-volatile random access memory (NVRAM). The processor 152 typically performs logical and arithmetic operations based on program instructions stored within the memory 154. The instructions in the memory 154 may be executable (by the processor unit 152, for example) to implement the methods described herein.

The processor unit 152 may comprise or be a component of a processing system implemented with one or more processors. The one or more processors may be implemented with any combination of general-purpose microprocessors, microcontrollers, digital signal processors (DSPs), floating point gate arrays (FPGAs), programmable logic devices (PLDs), controllers, state machines, gated logic, discrete hardware components, dedicated hardware finite state machines, or any other suitable entities that can perform calculations or other manipulations of information.

The processor unit 152 may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, RS-274 instructions (G-code), numerical control (NC) programming language, and/or any other suitable format of code). The instructions, when executed by the one or more processors, cause the processing system to perform the various functions described herein.

The computer 150 may also include a signal detector 156 that may be used to detect and quantify any level of signals received by the computer 150 for use by the processing unit 152 and/or other components of the computer 150. The signal detector 156 may detect such signals as energy beam source 103 power, scanner 105 position, build floor 111 height, amount of powder 117 remaining in depositor 101, leveler 119 position, and other signals. Signal detector 156, in addition to or instead of processor unit 152 may also control other components as described with respect to the present disclosure. The computer 150 may also include a DSP 158 for use in processing signals received by the computer 150. The DSP 158 may be configured to generate instructions and/or packets of instructions for transmission to PBF system 100.

The computer 150 may further comprise a user interface 160 in some aspects. The user interface 160 may comprise a keypad, a pointing device, and/or a display. The user interface 160 may include any element or component that conveys information to a user of the computer 150 and/or receives input from the user.

The various components of the computer 150 may be coupled together by a bus system 151. The bus system 151 may include a data bus, for example, as well as a power bus, a control signal bus, and a status signal bus in addition to the data bus. Components of the computer 150 may be coupled together or accept or provide inputs to each other using some other mechanism.

Although a number of separate components are illustrated in FIG. 1E, one or more of the components may be combined or commonly implemented. For example, the processor unit 152 may be used to implement not only the functionality described above with respect to the processor unit 152, but also to implement the functionality described above with respect to the signal detector 156, the DSP 158, and/or the user interface 160. Further, each of the components illustrated in FIG. 1E may be implemented using a plurality of separate elements.

By way of example, an element, or any portion of an element, or any combination of elements may be implemented using one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors may execute software as that term is described above.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, compact disc (CD) ROM (CD-ROM) or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, digital versatile disc (DVD), floppy disk and Blu-ray disc where disks usually reproduce data magnetically, while discs reproduce data optically with lasers. Thus, computer readable medium comprises a non-transitory computer readable medium (e.g., tangible media).

At a high-level, the present disclosure describes a system that provides benefits including at least thermal management, serviceability, process monitoring, and system cost.

There are three main sources of heat generation that impact the overall beam quality. First, heat is generated as a results of mechanical movement of galvos and other moving objects to move the lens to specific zoom and focus points. Second, lenses, mirrors, and other optic objects exposed to high laser power and long exposure of time (e.g., thermal lensing). Third, heat generated and reflected from the chamber by conduction, force convention, and tradition from the chamber back to the monolithic multi-optics scanner head housing.

Mitigating this heat generation through an monolithic multi-optics scanner head housing (e.g., a 3D printed monolithic housing) will become an increasingly desired system characteristic since power handling+1 kW may be come cumbersome for thermal management. Such monolithic embodiments may also be additively manufactured with integrated channels and conformal cooling. The monolithic head can have integrated passages with a single supply nozzle connected to each of the multiple sets of galvos to receive and carry gas, air, and/or water to certain areas of the head to cool down portions affected by heat. Gas can also be injected at certain angles with a single supply nozzle having a certain nozzle shape to optical apparatus such as mirrors and lenses.

In addition, cooling liquid channels can address heat generated from galvos and bounced back from the scanners. Actively managing the thermal aspect of the scanner while using multi-mode laser power may support achieving consistently high laser utilization. Alternative solutions may include higher-cost substrates and/or coatings.

Second, the monolithic multi-optics scanner head housing enables a novel servicing strategy to achieve greater machine availability & uptime, which is a primary goal for a best-in-class factory. As described above, the present disclosure describes an approach of pre-calibrating each optical bench and maintaining hot-swappable backups that may be quickly exchanged. Fine-tuning on an individual printer installation may be minimal and accomplished by automated, in-house developed fiber alignment and multi-field calibration software. Assuming these exchanges can be rapidly completed, more frequent optical calibration and better cleaning ex-situ may be performed in parallel rather than requiring multiple days of planned machine downtime per quarter.

In some examples, the monolithic multi-optics scanner head housing may have a single data and single power inlet and less process piping by a factor of the number of optical tracks. In addition, simplifying the printer structure has direct benefits during initial fabrication and a carry-over benefit to mean time between unplanned service events.

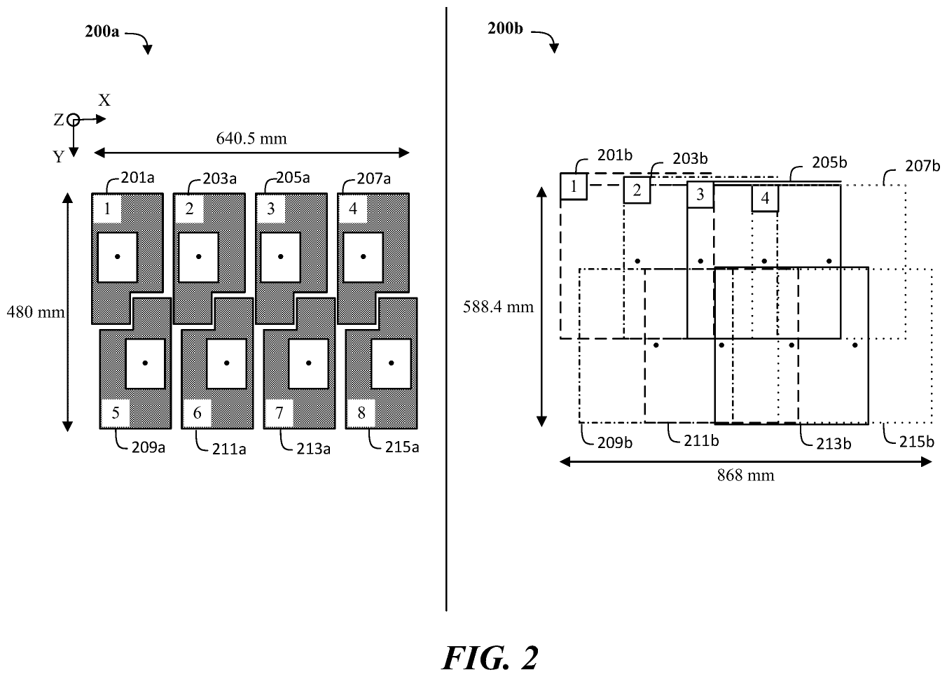

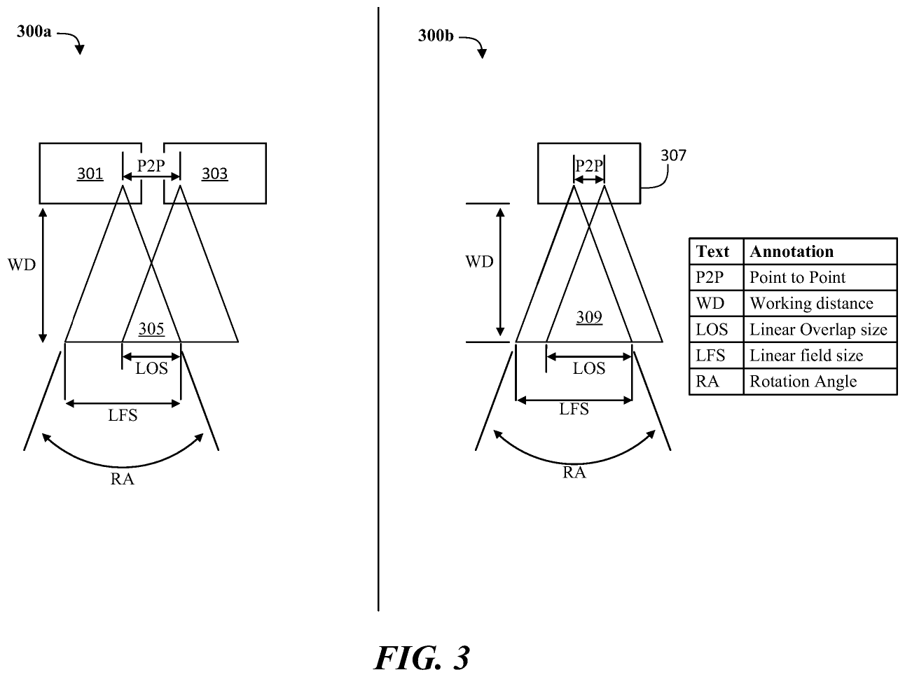

Third, the present disclosure provides a method of integrating photodiodes, cameras, power monitoring, and other components to minimize impact to beam quality. Many scanner manufacturers have separate modules for separating the visible and thermal wavelengths so users may add photodiodes and/or pyrometers. However, adding support for new capabilities is a lengthy process, rather than something that can be quickly added and iteratively improved. Directly adding sensors into the monolithic housing allows for shared sensors for optic health, calibration, and process monitoring. The integration of multiple optics into a single, monolithic housing can allow greater overlap of the laser regions in a multi-laser system, which can increase the printing efficiency of the system because more lasers can be concentrated on any given area of the powder bed. Laser region overlap is described in more detail below with respect to FIGS. 2 and 3.

Finally, the present disclosure improves printer integration via streamlined connections of the printer-supplied utilities (e.g., filtered compressed air coolant) and fiber optic cables from the laser module. Initially and increasingly over time, the integrated, printed housing should trade favorably with low material efficiency, machined individual housings.

### Monolithic Multi-Optics Scanner Head

Increasing productivity and simultaneously maintaining material quality is the main criteria to bend the economy curve towards competitive solutions to conventional manufacturing. However, this requires both software and hardware development. For example, software is needed to assign optic solutions for individual pixels based on factors that not only maximize the laser up-time, but also manages the thermal impact both on the parts and optics being used with a multi-lasers work for generating parts every layer of the multi-layer process to minimize anisotropy. For hardware, there is a requirement to achieve maximum productivity including, but not limited to packing multi-optic paths with a maximum number of optics, maximizing the overlap of the scanner by reducing point to point of each individual optic, increasing laser power with appropriate thermal management, and managing beam size and shape to generate stable, repeatable, and producible melt pool while maintaining beam quality.

Packaging optimization allows components to be more flexibly and closely positioned to maximize the overlapping laser fields. Packaging optimization may also enable the packaging of more optics (or scanner heads) to address a given size build plate.

FIG. 2 illustrates a configuration of a schematic of individual multi-head individual scanner heads packed as a cluster. Example 200a of FIG. 2 shows a first scanner head 201a, a second scanner head 203a, a third scanner head 205a, a fourth scanner head 207a, a fifth scanner head 209a, a sixth scanner head 211a, a seventh scanner head 213a, and an eighth scanner head 215a tightly packed into a cluster to increase the productivity of printing with maximized individual scanner overlaps.

In the context of PBF laser beam equipment, scanner heads are an optical component that directs, focuses, and controls a laser beam to accurately melt the powder material in the additive manufacturing process. Specifically, a scanner head is an optical component that directs the laser beam across the powder bed via a beam entry window to selectively melt and fuse the material, layer-by-layer, to create a 3D object. The key functions of a scanner head include at least beam steering, and focusing. The scanner head may contain a set of galvos that rapidly and precisely adjust the angle of the laser beam. This steering capability allows the laser to be directed to specific locations on the powder bed where the material needs to be melted. In addition, the scanner head includes optical lenses that focus the laser beam to a small, precise spot size on the powder bed. The quality of the focus helps achieve the necessary energy density to melt the powder material accurately.

As shown in example 200a and example 200b of FIG. 2, FIG. 2 shows a configuration with a working distance (WD) of 511 mm as an example with 2×4 arrays of scanner heads 201a, 203a, 205a, 207a, 209a, 211a, 213a, 215a tightly nested together in a cluster. In systems, such as in example 200b, when scanner heads 201a, 203a, 205a, 207a, 209a, 211a, 213a, 215a are clustered together due to limited space, working distance is a parameter that ensures that each head can function optimally without interferences and maintaining the correct focus on the target surface or object. The working distance refers to the distance between the scanner head (e.g., specifically the lens or front of the optical assembly) and the object or surface it is focused on. Generally, the working distance may reduce the depth of field, while a shorter working distance may increase it. Accordingly, the working distance helps ensure that each scanner head in the cluster can focus accurately on the target surface. For example, if the working distance is too short or too long, the image or data captured by the scanner head may be blurry or out of focus.

For example, for the configuration of 2×4 arrays of individual scanner heads cluster, an optimized packaging can increase the number of scanner heads per identical footprint to 2×5 or 2×6, which increases the machine throughput (e.g., example of 10 or 12 scanner heads versus 8 scanner heads for a current for a 420×720 mm platform).

As noted above, having a 2×4 array of individual scanner head clusters provides the advantage of only needing a single glass (e.g., instead of 8 separate glasses for each scanner head) for the entire package. This may make the whole calibration cycle more streamlined since there is only a single beam entry window (e.g., glass) to maintain rather than 8 separate beam entry windows. As explained above, the beam entry window is a window between the scanner and the build chamber and protects the optical components from the harsh environment inside the build chamber, including metal vapor and powder particles.

Example 200b of FIG. 2 shows corresponding laser regions on the powder bed that each scanner head may reach. For example, laser region 203b (as depicted in dashed-dotted lines) from the second scanner head 203a shows that overlap may reach into the other regions of the lasers from other scanner heads. Specifically, laser region 203b from the second scanner head 203a may overlap the regions of laser region 201b (as depicted dashed lines) from the first scanner head 201a, laser region 205b (depicted as solid line) from the third scanner head 205a, laser region 207b (as depicted a dotted line) from the fourth scanner head 207a, laser region 209b (depicted as a dashed-dotted line) from the fifth scanner head 209a, laser region 211b (depicted as a dashed line) from the sixth scanner head 211a, laser region 213b (depicted as a solid line) from the seventh scanner head 213a, but not the laser region 215b (depicted as a dotted line) from the eighth scanner head 215a. Accordingly, it should be noted that there is overlap in both the X-axis directions. Having the overlap in both X directions makes calibration less challenging since this is one less overlap to deal with.

It should be noted that although the configuration shows a configuration of 2×4 configuration for illustrative purposes only and that the present disclosure may apply to any other configurations such as 2×1 or 2×2 or 2×8 configurations.

FIG. 3 illustrates a comparison of schematics of packaging optimization with individual scanners 301, 303 having multi-field overlap 305 and packaging optimization with integrated scanner heads 307 (e.g., a monolithic multi-optics scanner head housing) having multi-field overlap 309. As shown in FIG. 3, the point to point of the integrated scanner head multi field overlap 309 shown in example 300b may increase proportionally by a linear factor as compared to individual scanner heads multi field overlap 305 shown in example 300a.

In some examples, the packaging flexibility of an individual scanner may also benefit the challenge of incorporating a zoom function to maximize the beam size.

The primary factor for both thermal management and productivity after packaging optimization is to maximize overlap between the lasers. This may be accomplished in two ways.

The first way is to increase the working distance with a penalty of losing resolution. Theoretically, 100% overlap may be achieved when a working distance converges to infinity. However, laser powder bed fusion (PBF-L) technology is limited to in chamber form factor that normally does not allow an increase Z height over a certain level due to, e.g., gas flow concerns. In addition, increasing the working distance will impact the resolution of a spot in the projected build plate.

The second way is to tightly pack the scanner heads together, as shown above in FIG. 2. Ideally, if optics point to point move to zero distance from each other, 100% overlap will be achieved. The impact of achieving higher field overlap is complex. It is understandable that an ideal configuration with 100% overlap eases the laser assignment strategy by random choice of an optic per each position reference in the printer build plate. Yet, it is clear that more overlap will allow for more potential scan field partitioning solutions to be identified that better meet overall process objectives and respect constraints such as minimizing laser-soot interaction.

These embodiments may not be physically achieved more than what was presented in the configuration shown in example 300a of FIG. 3 unless physical constraints may be removed and all galvos sets are closely packed together. Galvos are devices used to deflect the laser beam with a mirror through a beam entry window to scan the laser beam across the powder bed. In some embodiments, the beam entry window may be a single window for all galvos. In some embodiments, each galvo may have its own respective beam entry window.

Specifically, in PBF AM, galvos play an important role in the scanner heads that direct or redirect the laser beam to selectively melt and fuse powder particles to build up a part layer by layer. Galvos may have different roles in the scanner heads such as beam steering, high-speed scanning, precision and accuracy, dynamic focus adjustment, or complex path generation.

First, galvos may be used to steer the laser beam across the powder bed via the beam entry windows with high precision and speed. For example, a galvo scanner head may typically consist of two galvos, each controlling a mirror. One galvo controls the X-axis movement and the other controls the Y-axis movement. By adjusting the angles of the mirrors, the laser beam can be directed to any point via the beam entry window on the powder bed, which allows for precise control over where the laser melts the powder.

Second, galvos may move mirrors very quickly, enabling rapid scanning of the laser beam across the power bed. This high-speed operation is desired for efficient layer-by-layer construction. Faster scanning speeds also translate to shorter build times, increasing the overall productivity of the PBF process.

Third, the feedback control systems in galvos ensure that the mirror positions are highly accurate, allowing for precise control over the position of the laser beam. This precision is crucial for achieving high-resolution features and maintaining the dimensional accuracy of the final part.

Fourth, some advanced scanner heads may incorporate a third galvo to dynamically adjust the focus of the laser beam. This ensure that the laser maintains the correct focal point on the powder bed, even as the mirrors move. Maintaining a consistent focal point is desired for uniform energy distribution and consistent melting of the powder.

Galvos also enable the laser to follow complex paths and geometries, which is desired for creating intricate and detailed parts. The ability to rapidly change the laser's path allows for the creation of complex internal structures and fine details that would be difficult or impossible with traditional manufacturing methods.

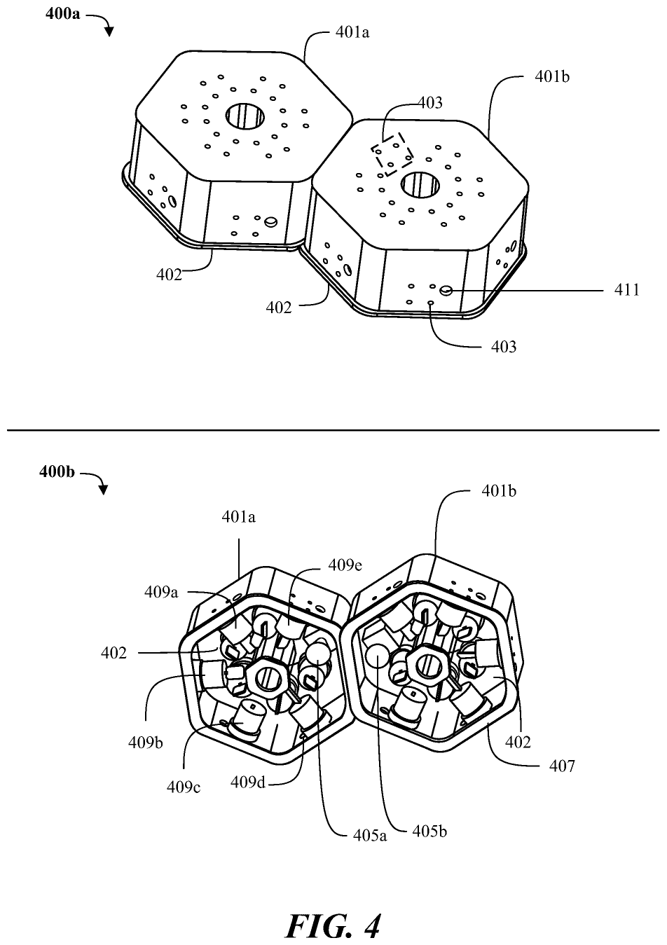

FIG. 4 illustrates different views of a configuration that includes five sets of galvanometers in accordance with an aspect of the present disclosure.

As shown in FIG. 4, examples 400a and 400b show two views of monolithic multi-optics scanner head housings 401a, 401b placed right next to each other when installed in a printer, with 400a being a top perspective view and 400b being a bottom perspective view. Each individual housing may hold up to 6 scanner heads or optics each (e.g., five sets of galvos 409a, 409b, 409c, 409d, 409e, and a camera 405a). A beam entry window 402 may be made of transparent glass covering the opening of the bottom of each monolithic multi-optics scanner head housing 401a, 401b. For purposes of illustration, beam entry windows 402 in FIG. 4 are shown completely invisible so the contents inside each housing 401a, 401b (e.g., the galvos and cameras) can be seen more clearly. The beam entry window 402 is typically a transparent component that allows the laser beam from scanner heads to enter the optical path without significant distortion or loss. In some examples, the window is made of an optical-grade material such as glass or a specific type of crystal that is transparent to the wavelength of the laser being used. The beam entry window 402 is important for maintaining the integrity of the laser beam as it enters the galvo system for precise scanning or positioning.

In some examples, the monolithic multi-optics scanner head housing may be additively manufactured such that complex features such as integrated channels, tubes, and cooling radiator fins are additively manufactured directly into the monolithic multi-optics scanner head housing. Additive manufacturing has allowed for the creation of complex non-linear geometries that are difficult or impossible to produce using traditional subtractive manufacturing methods. In this way, the integrated channels, tubes, and cooling radiator fins can be integrated into the housing in optimal configurations regardless of how intricate they are. In addition, additive manufacturing enables the production of internal channels and cooling tubes directly within the housing itself and without additional parts or assembly steps. These internal features can be designed to follow the contours of the scanner head, ensuring efficient heat dissipation from specific hot spots.

As a non-limiting example, each of the monolithic multi-optics scanner head housings 401a, 401b has a hexagonal set with five galvo sets 409a, 409b, 409c, 409d, 409e for a total of ten galvos in the system. In addition, there will be one set of galvos for each laser beam and a respective beam entry window for each laser beam. In some examples, the two housings may hold a total of 10 scanner heads and two lasers.

As compared with the 2×4 array of scanner head clusters in FIG. 2, a benefit of a hexagonal structure is that each scanner head has their own pieces, which are spaced apart. For example, in a hexagonal arrangement, each optic typically has fewer immediate neighbors compared to the 2×4 array. Additionally, having the hexagonal geometry provides even more spacing and, thus, easier access to each optic-especially from the edges. This allows for better maneuverability and more direct access to the individual scanner heads.

In contrast, compared to the 2×4 array of scanner head cluster, the scanner heads are tightly packed in a rectangular grid, meaning each scanner head is surrounded by neighbors on multiple sides. This makes it challenging to access individual scanner heads, especially if they are tightly packed. The limited space between the scanner heads may also restrict the ability to maneuver tools, which increases the difficulty of removal or replacement without disturbing adjacent scanner heads. Thus, if there are ever any issues with just a single or two of the scanner heads in the monolithic multi-optics scanner head housings 401a, 401b, then it is easier to remove and/or replace the one piece as opposed to the configuration of a schematic of individual multi-head individual scanner heads packed as a cluster shown in FIG. 2.

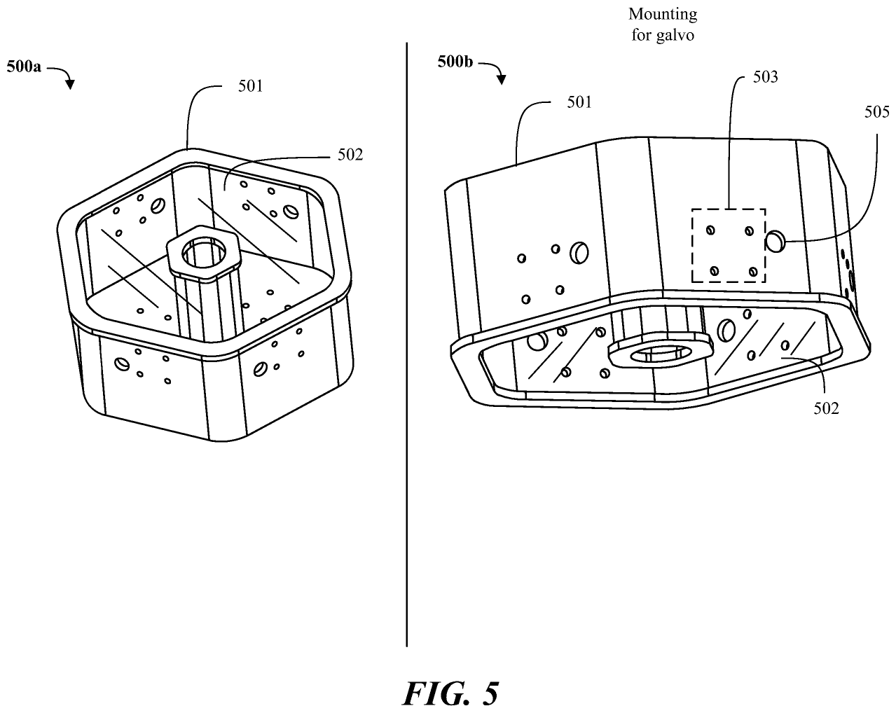

As shown in example 400a, the monolithic multi-optics scanner head housing 401a, 401b, may have sets of mounting holes 403 for the galvos 409a-e and cameras 405a-b, and laser beam pass through holes 411. More detail about the mounting holes and laser beam pass through holes may be explained in FIG. 5.

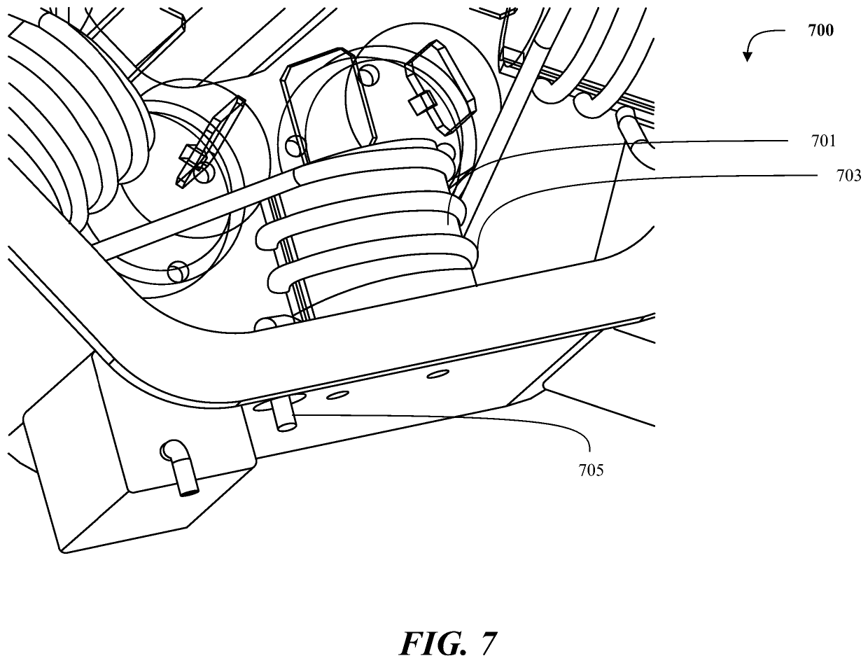

Furthermore, the monolithic multi-optics scanner head housing may incorporate integrated cooling channels 407 as will be shown in more detail in FIG. 7, or add additional functionalities for process monitoring such as cameras or sensors directly within the unit.

Among other advantages, one of the advantages of having monolithic multi-optics scanner head housing is the ability to integrate photodiodes, cameras, power monitoring devices, or any other components in way that minimizes impact to beam quality. Directly sensorizing the components into the monolithic housing allows for shared sensors for optic health, calibration, and process monitoring.

As a non-limiting example, as shown in example 400b, cameras 405a, 405b may be placed closer to the center of the combined monolithic multi-optics scanner head housing 401a, 401b for process monitoring.

FIG. 5 illustrates two views 500a,500b of a monolithic multi-optics scanner head housing 501 without galvos or other internal components to more clearly shows mounting holes and laser beam pass throughs in accordance with an aspect of the present disclosure. For purposes of illustration to show the positioning of the beam entry window, a beam entry window 502 is also shown, though it is noted that the beam entry window typically would not be installed until after the internal components of the housing 501 are installed.

As shown in examples 500a and 500b, the monolithic multi-optics scanner head housing 501 is shown without any galvos.

For example, as shown in example 500b, there are mounting holes for the galvo 503 and laser beam pass throughs 505.

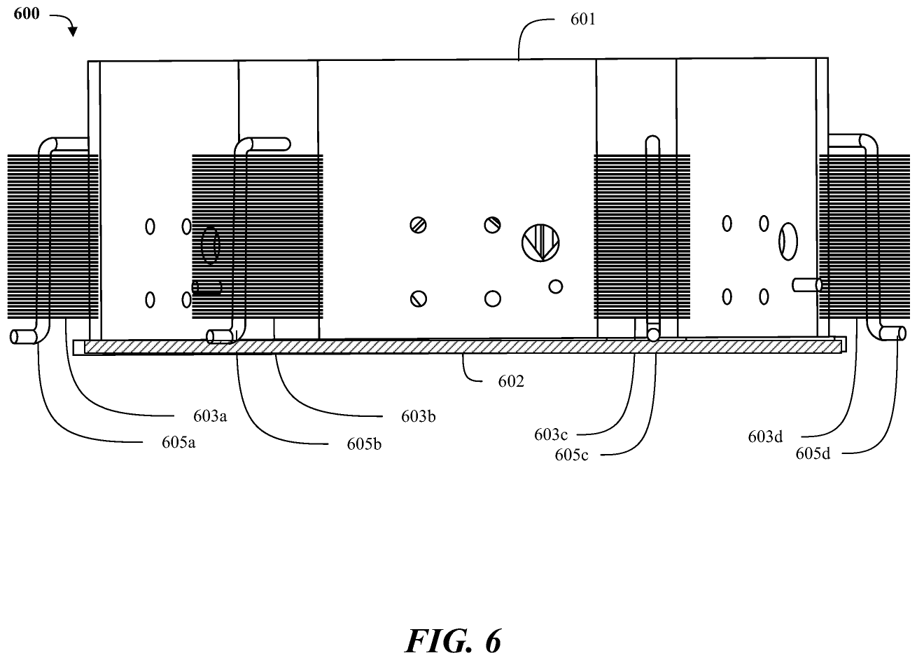

FIG. 6 illustrates a view of a configuration that shows printed—in radiator fins and a heat exchanger in accordance with an aspect of the present disclosure.

Example 600 of FIG. 6 shows an example monolithic multi-optics scanner head housing 601 with a beam entry window 602 and a set of printed—in radiator fins/heat exchangers as part of a radiator structure. For example, the galvos, mirrors, and other electronic components within the scanner heads produce a significant amount of heat during operations. The excessive heat may cause thermal expansion and distortion of the scanner head components which can also lead to misalignment of the laser beam, reducing the precision and accuracy of the scanning process. In addition, prolonged exposure to high temperatures may degrade electronic components, reducing their lifespan and reliability. Thus, effective thermal management is crucial to ensure the reliability, accuracy, and longevity of the scanner heads.

A radiator structure may refer to a system or component designed to dissipate heat away from a source. The primary function of a radiator structure is for thermal management. As an example, thermal management may include transferring heat from a hot object or fluid to cooler environment to help regulate temperature and prevent overheating. In some example, the radiator structure may contain fins with thin, flat surfaces extending from the main body and/or tubes or channels through which a coolant fluid flows. The fluid absorbs heat from a hot source and transfers it to the radiator. In some examples, the radiators may be made from metals (e.g., aluminum, copper, or steel), which have high thermal conductivity to allow an efficient transfer of heat. In some examples, liquid coolant may circulate throughout the radiator structure to absorb heat from the system and release it through to the printed—in radiator fins. In some examples, air is the primary medium for cooling, where air flows over the radiator's surface to remove heat.

Printed—in radiator fins and heat exchangers with tubes 605a, 605b, 605c, 605d and printed—in radiator fins 603a, 603b, 603c, 603d may be part of the radiator structure and are examples of components that may be used in the thermal management of scanner heads, particularly in high-power applications like those found in PBF AM. In various embodiments, cooling fins may be used without tubes. In various embodiments, tubes may be used without cooling fins.

In particular, generally, printed—in radiator fins 603a, 603b, 603c, 603d may be thin, flat surfaces that extend from tubes attached to the monolithic multi-optics scanner head housing 601. The printed—in radiator fins 603a, 603b, 603c, 603d work by increasing the surface area available for heat dissipation. Accordingly, the increased surface area provided by the printed—in radiator fins 603a, 603b, 603c, 603d allow for more efficient heat transfer, which helps to maintain lower operating temperatures.

Unlike traditional fins that are attached to a surface after the component is made, printed—in fins are created as part of the component itself, directly during the manufacturing process. In some examples, these printed—in radiator fins are printed using 3D printing technologies like additive manufacturing, which allows for complex geometries that may be difficult or impossible to achieve with traditional manufacturing methods. The primary function of the printed—in radiator fins is to improve the thermal management of devices, helping to prevent overheating and ensuring stable operation by increasing the surface area of the component to dissipate heat into the surrounding environment.

In addition, as shown in example 600, the monolithic multi-optics scanner head housing 601 contains heat exchangers with tubes and printed—in radiator fins 603a, 603b, 603c, 603d. The tubes 605a, 605b, 605c, 605d may carry a coolant fluid, while the printed—in radiator fins 603a, 603b, 603c, 603d are attached to the tubes 605a, 605b, 605c, 605d to enhance heat transfer from the scanner head components to the coolant fluid. In this way, heat may be carried away from the system. Furthermore, as explained above, the printed—in radiator fins 603a, 603b, 603c, 603d attached to the tubes increase the surface area for heat exchange, improving the efficiency of the cooling process. In some examples, the heat coolant is circulated through the heat exchanger and then cooled down, either by an external cooling system or passing through a radiator.

The benefits of using printed—in radiator fins (or cooling fins) and heat exchangers include at least temperature control, precision and accuracy, component longevity, and system efficiency. An effective cooling mechanism helps maintain a stable operating temperature for the scanner head components. This prevents overheating and ensures consistent performance. By minimizing thermal distortion, printed—in radiator fins and heat exchangers help maintain the alignment and accuracy of the laser beam, which is crucial for achieving high-resolution features and dimensional accuracy in the final parts. In addition, proper thermal management reduces the thermal stress on electronic components, extending their lifespan and reliability. This leads to lower maintenance costs and fewer system failures. Furthermore, the efficient heat dissipation also allows the scanner head to operate at higher power levels without overheating.

It should be noted that printed—in radiator fins and/or tubes are described herein to illustrate components designed to dissipate heat away from a source, this is for illustrative purposes only and any other type of components with the same function may be utilized in the present disclosure.

FIG. 7 illustrates a view of a configuration that shows thermal management channels, e.g., tubes, and inlet/outlets corresponding to a set of galvos in accordance with an aspect of the present disclosure.

As shown in example 700, an monolithic multi-optics scanner head housing may have a conformal channel 703 (cooling or heating) wrapped around the galvo set 701. The conformal channel 703 may have a corresponding liquid inlet/outlet 705 These conformal channels 703 may have integrated passages to carry gas, air, and/or water to certain areas to cool down the heat generated by the objects. For example, heat and conformal cooling liquid channels may address heat generated from galvos and bounced back from scanners.

In some examples, the conformal channel 703 may also extend to other sets of galvos such that a single channel may be configured for thermal management through the multiple sets of galvos.

As an example, in operation the scanner head will include high-power galvos 701 (e.g., 409a, 409b, 409c, 409d, 409e from FIG. 4), mirrors, or other electronic components (e.g., cameras 405a from FIG. 4). In some examples, the printed—in radiator fins (printed—in radiator fins 603a, 603b, 603c, 603d from FIG. 6) may be attached directly to the galvos and/or other heat-generating components such as conformal channels 703 (tubes 605a, 605b, 605c, 605d from FIG. 6). The printed—in radiator fins conduct heat away from these components and dissipate it into surrounding area. The conformal channels 703 carry a coolant fluid that absorbs heat from the scanner head. The printed—in radiator fins on the heat exchanger also enhance the heat transfer from the conformal channels 703 to the coolant fluid. In some aspects, the heated coolant is circulated through the heat exchanger and then cooled down by an external cooling system.

It should be noted that the present disclosure describes liquid cooling channels and fins for illustrative purposes only, the present disclosure may also apply to heating channels.

### Advantages Provided by the Present Disclosure

In an aspect of the present disclosure, the disclosure provides a system and apparatus for an monolithic multi-optics scanner head housing. For instance, the monolithic multi-optics scanner head housing can be additively manufactured with integrated conformal channels (e.g., 703) and conformal cooling (e.g., fins 603a, 603b, 603c, 603d). In addition, the monolithic heads may have integrated passes to carry gas and/or water to reduce heat generation. As another example, the integrated housing enables a novel servicing strategy since the monolithic heads can have a single data and single power inlet. This allows the monolithic heads to be pre-calibrated and be easily hot-swappable in a printer. In addition, the monolithic multi-optics scanner head housing may integrated photodiodes, cameras, power monitoring, and other components for process monitoring in a way that minimizes impact to beam quality.

The previous description is provided to enable any person skilled in the art to practice the various aspects described herein. Various modifications to these exemplary embodiments presented throughout this disclosure will be readily apparent to those skilled in the art, and the concepts disclosed herein may be applied to other techniques for printing structures and interconnects. Thus, the claims are not intended to be limited to the exemplary embodiments presented throughout the disclosure, but are to be accorded the full scope consistent with the language claims. All structural and functional equivalents to the elements of the exemplary embodiments described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f), or analogous law in applicable jurisdictions, unless the element is expressly recited using the phrase “means for” or, in the case of a method claim, the element is recited using the phrase “step for.”

What is claimed is:

1. An apparatus, comprising:
a monolithic multi-optics scanner head housing configured to receive multiple sets of galvanometer mirror scanners (galvos) and a beam entry window, wherein each set of galvos receives a laser and redirects the laser using a mirror.

2. The apparatus of claim 1, wherein the monolithic multi-optics scanner head housing further comprises a conformal channel with a channel configured for thermal management through the multiple sets of galvos.

3. The apparatus of claim 1, wherein each set of galvo further comprises a set of printed—in radiator fins, radiator structure, or heat exchangers for thermal management of the multiple sets of galvos.

4. The apparatus of claim 1, wherein the monolithic multi-optics scanner head housing further comprises a single air channel for thermal management of the multiple sets of galvos.

5. The apparatus of claim 1, wherein monolithic multi-optics scanner head housing further comprises a single supply nozzle that is connected to each of the multiple sets of galvos to receive gas.

6. The apparatus of claim 1, wherein monolithic multi-optics scanner head housing further comprises a single data inlet or power inlet that connects to each of the multiple sets of galvos.

7. The apparatus of claim 1, wherein the monolithic multi-optics scanner head housing further comprises at least two beam entry window for a plurality of lasers.

8. The apparatus of claim 6, wherein the monolithic multi-optics scanner head housing further comprises a respective beam entry window for each laser.

9. The apparatus of claim 1, wherein the monolithic multi-optics scanner head housing is further configured to receive a camera for process monitoring.

10. The apparatus of claim 1, wherein the monolithic multi-optics scanner head housing is further configured to receive a sensor.

11. The apparatus of claim 1, wherein the monolithic multi-optics scanner head housing further comprises a set of mounting holes configured to mount each set of galvos, camera, or a sensor and a corresponding single hole for receiving a laser beam.

12. The apparatus of claim 1, wherein the monolithic multi-optics scanner head housing further comprises a hexagonal shape such that each side of the hexagonal shape comprises a set of mounting holes configured to receive at least a set of galvos, a camera, or a sensor.

13. The apparatus of claim 1, wherein the monolithic multi-optics scanner head housing is additively manufactured.

14. A system for:
a monolithic multi-optics scanner head housing configured to receive a single set of galvanometers (galvos) configured to receive a laser and redirect the laser using a mirror, wherein the monolithic multi-optics scanner head housing comprises a conformal channel with a channel configured for thermal management through the single set of galvos.

15. The system of claim 14, wherein the monolithic multi-optics scanner head housing further comprises a conformal channel with a channel configured for thermal management through the single set of galvos.

16. The system of claim 14, wherein each set of galvo further comprises a set of printed—in radiator fins, radiator structure, or heat exchangers for thermal management.

17. The system of claim 14, wherein the monolithic multi-optics scanner head housing further comprises a single air channel for thermal management of the single set of galvos.

18. The system of claim 14, wherein monolithic multi-optics scanner head housing further comprises a single supply nozzle that is connected to each of the single set of galvos to receive gas.

19. The system of claim 14, wherein monolithic multi-optics scanner head housing further comprises a single data inlet or power inlet that connects to the single set of galvos.

20. The system of claim 18, wherein the monolithic multi-optics scanner head housing further comprises a respective beam entry window for each laser.

21. The system of claim 14, wherein the monolithic multi-optics scanner head housing is further configured to receive a camera for process monitoring.

22. The system of claim 14, wherein the monolithic multi-optics scanner head housing is further configured to receive a sensor.

23. The system of claim 14, wherein the monolithic multi-optics scanner head housing further comprises a set of mounting holes configured to mount each set of galvos, camera, or a sensor and a corresponding single hole for receiving a laser beam.

24. The system of claim 14, wherein the monolithic multi-optics scanner head housing is additively manufactured.
